(19) United States
(12) Patent Application Publication
(10) Pub. No.: US 2011/0113187 A1
(43) Pub. Date: May 12, 2011

(54) SEMICONDUCTOR DEVICE AND METHOD FOR CONTROLLING THE SAME

(76) Inventor: Jin KASHIWAGI, Yokohama-shi (JP)

(21) Appl. No.: 12/884,590

(22) Filed: Sep. 17, 2010

(30) Foreign Application Priority Data
Nov. 6, 2009 (JP) 2009-255311

(51) Int. Cl. G06F 12/02

(52) U.S. Cl. 711/103; 711/E12.008

(57) ABSTRACT

According to one embodiment, a semiconductor device includes a NAND flash memory, an SRAM, and a controller. The NAND flash memory includes a plurality of blocks with a plurality of memory cells and a decoder which selects the blocks. The NAND flash memory is capable of erasing data in a plurality of the blocks simultaneously during a multi-block erase operation. The decoder stores bad-block information at least during a read operation and a write operation and stores information on a plurality of erase target blocks during the multi-block erase operation. The SRAM stores the information on the erase target blocks. The controller reads information on the erase target blocks from the SRAM to set the information into the decoder in a multi-block erase operation.

### CROSS-REFERENCE TO RELATED APPLICATIONS

This application is based upon and claims the benefit of priority from Japanese Patent Application No. 2009-255311, filed Nov. 6, 2009; the entire contents of which are incorporated herein by reference.

### FIELD

Embodiments described herein relate generally to a semiconductor device and a method for controlling the semiconductor device.

### BACKGROUND

A NAND flash memory which is capable of erasing a plurality of blocks simultaneously is known and disclosed in, for example, Jpn. Pat. Appln. KOKAI Publication No. 2007-179687.

According to a technique disclosed in Jpn. Pat. Appln. KOKAI Publication No. 2007-179687, in a decoder for selecting blocks, one latch circuit holds information on the blocks to be erased simultaneously and bad-block information. This serves to reduce the number of circuit elements.

### BRIEF DESCRIPTION OF THE DRAWINGS

FIG. 1 is a block diagram of a memory system according to a first embodiment;

FIG. 2 is a block diagram of a NAND flash memory according to the first embodiment;

FIG. 3 is a circuit diagram of a row decoder according to the first embodiment;

FIG. 4 is a flowchart showing the operation of a memory system according to the first embodiment;

FIG. 5 is a timing chart of various signals according to the first embodiment;

FIG. 6 is a schematic diagram of SRAM according to a second embodiment;

FIG. 7 is a circuit diagram of a row decoder according to the second embodiment;

FIG. 8 and FIG. 9 are flowcharts showing the operation of the memory system according to the second embodiment;

FIG. 10 is a timing chart of various signals according to the second embodiment;

FIG. 11 is a flowchart showing the operation of the memory system according to a modification of the first embodiment; and

FIG. 12 is a sectional view of a memory system according to a modification of the first and second embodiments.

### DETAILED DESCRIPTION

According to the technique disclosed in Jpn. Pat. Appin. KOKAI Publication No. 2007-179687, in a decoder for selecting blocks, one latch circuit holds information on blocks to be erased in a batch and bad-block information. This serves to reduce the number of circuit elements. However, this configuration has difficulty suspending an operation of erasing a plurality of blocks simultaneously.

In general, according to one embodiment, a semiconductor device includes: a NAND flash memory; an SRAM; and a controller. The NAND flash memory includes a plurality of blocks with a plurality of memory cells and a decoder which selects the blocks. The NAND flash memory is capable of erasing data in a plurality of the blocks simultaneously during a multi-block erase operation. The decoder stores bad-block information at least during a read operation and a write operation and stores information on a plurality of erase target blocks during the multi-block erase operation. The SRAM stores the information on the erase target blocks. The controller reads information on the erase target blocks from the SRAM to set the information into the decoder in a multi-block erase operation.

### FIRST EMBODIMENT

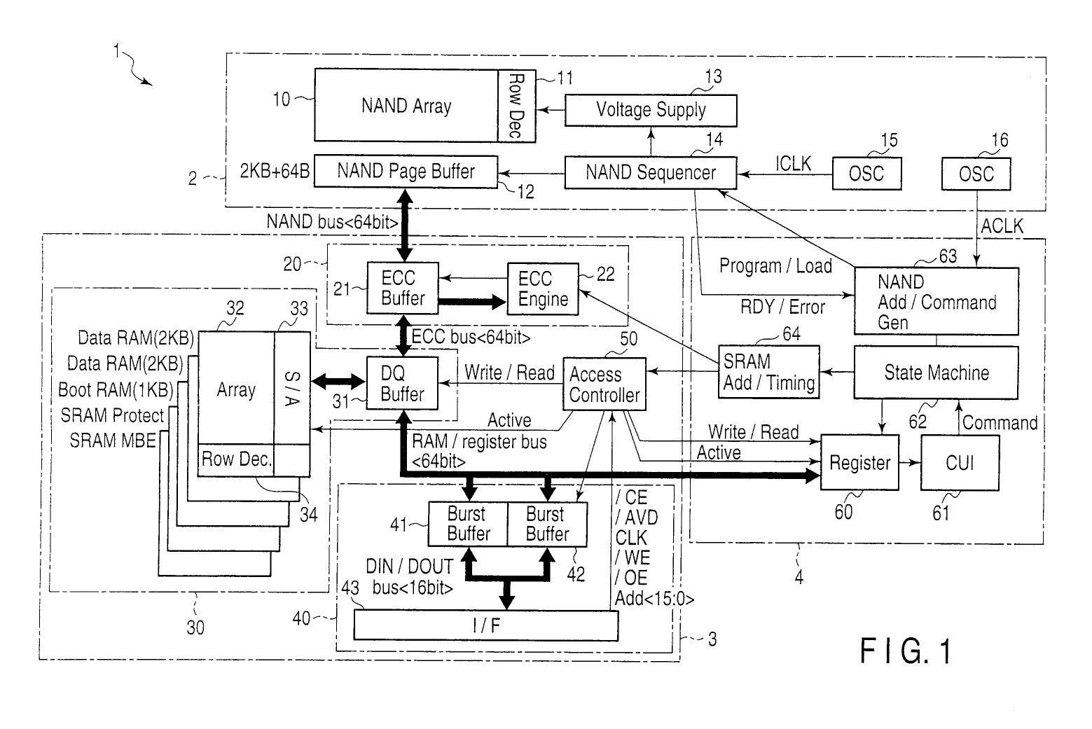

A semiconductor device and a method for controlling the semiconductor device according to the first embodiment will be described. FIG. 1 is a block diagram of a memory system according to the present embodiment.

### <General Configuration of the Memory System>

As shown in FIG. 1, a memory system 1 according to the present embodiment generally includes a NAND flash memory 2, a RAM unit 3, and a controller unit 4. The NAND flash memory 2, the RAM unit 3, and the controller unit 4 are formed on the same semiconductor substrate and integrated on one chip. Each of the blocks will be described below in detail.

### <NAND Flash Memory 2>

The NAND flash memory 2 functions as a main memory of the memory system 1. As shown in FIG. 1, the NAND flash memory 2 includes a memory cell array 10, a row decoder 11, a page buffer 12, a voltage supply 13, a sequencer 14, and oscillators 15 and 16.

The memory cell array 10 includes a plurality of selection transistors and a plurality of memory cell transistors capable of holding data. Each of the memory cell transistors is a MOS transistor with a stacked gate including a charge accumulation layer and a control gate. A gate of the selection transistor is connected to a selection gate line. The control gate of the memory cell transistor is connected to a word line. The memory cell array 10 includes a plurality of blocks each of which is a set of a plurality of memory cell transistors. Erase units for the memory cell array 10 are blocks. That is, data in the memory cell transistors included in the same block is erased simultaneously. Furthermore, in the NAND flash memory 2 according to the present embodiment, data in a plurality of blocks can be erased simultaneously. This is hereinafter referred to as Multi-Block Erase (MBE).

The row decoder 11 selects a word line and a selection gate line for a data program operation, a data read operation, and data erase operation. The row decoder 11 then applies required voltages to the word line and the selection gate line. The memory cell array 10 and the row decoder 11 will be described below in detail.

The page buffer 12 can hold data with a page size. During a data program operation, the page buffer 12 temporarily holds data provided by the RAM unit 3 and writes the data to the memory cell array 10. On the other hand, during a read operation, the page buffer temporarily holds data read from the memory cell array 10 and transfers the data to the RAM unit 3.

The voltage supply 13 increases and reduced externally provided voltage to generate voltages required for data programming, data read, and data erase. The voltage supply 13 supplies the generated voltages to, for example, the row decoder 11. The voltage generated by the voltage supply 13 is applied to a word line WL.

The sequencer 14 is responsible for the operation of the entire NAND flash memory 2. That is, upon receiving a program command (Program), a load command (Lord), or an erase command (not shown in the drawings) from the controller unit 4, the sequencer 14 executes a sequence for carrying out data programming, data read, or data erase in response to the command. Then, in accordance with the sequence, the sequencer controls the operation of the voltage supply 13 and the page buffer 12.

The oscillator 15 generates an internal clock ICLK. That is, the oscillator 15 functions as a clock generator. The oscillator 15 supplies a generated internal clock ICLK to the sequencer 14. The sequencer 14 operates in synchronism with the internal clock ICLK.

The oscillator 16 generates an internal clock ACLK. That is, the oscillator 16 functions as a clock generator. The oscillator 16 supplies a generated internal clock ACLK to the controller unit 4 and the RAM unit 3. The internal clock ACLK is a clock serving as a reference for the operation of the controller unit 4 and the RAM unit 3.

### <RAM Unit 3>

Now, still referring to FIG. 1, the RAM unit 3 will be described. The RAM unit 3 generally includes an ECC unit 20, Static Random Access Memory (SRAM) 30, an interface unit 40, and an access controller 50.

In the memory system 1 according to the present embodiment, the NAND flash memory 2 functions as a main memory, and SRAM 30 in the RAM unit 3 functions as a buffer. Thus, when data is read from the NAND flash memory 2 to an external apparatus, first, the data read from the memory cell array 10 in the NAND flash memory 2 is stored in SRAM 30 in the RAM unit 3 via the page buffer 12. Thereafter, the data in SRAM 30 is transferred to the interface unit 40, which then outputs the data to the external apparatus. On the other hand, when data is stored in the NAND flash memory 2, first, externally provided data is stored in SRAM 30 in the RAM unit 3 via the interface unit 40. Thereafter, the data in SRAM 30 is transferred to the page buffer 12 and then written to the memory cell array 10.

An operation for reading data from the memory cell array 10 and then transferring the read data to SRAM via the page buffer 12 is hereinafter referred to as data “load.” Furthermore, an operation for transferring the read data in SRAM 30 to an interface 43 in the interface unit 40 via burst buffers 41 and 42 is hereinafter referred to as data “read.”

Moreover, an operation for transferring data to be stored in the NAND flash memory 2 from the interface 43 to SRAM 30 via the burst buffers 41 and 42 is called data “write.” Additionally, an operation for transferring the data in SRAM 30 to the page buffer 12 and then writing the data in the NAND flash memory 2 is hereinafter referred to as data “program.”

The configurations of the ECC unit 20, SRAM 30, the interface unit 40, and the access controller 50 will be described below.

### <<ECC Unit 20>>

The ECC unit 20 detects and corrects errors in data and generates parities (these operations are sometimes collectively referred to as an ECC process). That is, during data loading, the ECC unit 20 detects and corrects errors in data read from the NAND flash memory 2. On the other hand, during data programming, the ECC unit 20 generates parities for data to be programmed. The ECC unit 20 includes an ECC buffer 21 and an ECC engine 22.

The ECC buffer 21 is connected to the page buffer 12 in the NAND flash memory 2 by a NAND bus and to SRAM 30 by an ECC bus. These buses have an equal bus width, for example, 64 bits. During data loading, the ECC buffer holds data transferred from the page buffer 12 via the NAND bus, and transfers data subjected an ECC process to SRAM 30 via the ECC bus. On the other hand, during data programming, the ECC buffer holds data transferred from SRAM 30 via the ECC bus, and transfers the transferred data and parities to the page buffer 12 via the NAND bus.

The ECC engine 22 carries out an ECC process using the data held in the ECC buffer 21. The ECC engine 22 uses, for example, a 1-bit correction scheme that uses humming codes. During data loading, the ECC engine 22 uses the parities to generate a syndrome to detect errors based on the syndrome. If any error is found, the ECC engine 22 corrects the error. On the other hand, during data programming, the ECC engine generates parities.

### <<SRAM 30>>

Now, SRAM 30 will be described. In the memory system 1, SRAM 30 functions as a buffer memory for the NAND flash memory 2. As shown in FIG. 1, SRAM 30 includes a DQ buffer 31, a plurality of (in the present embodiment, two) data RAMs, one boot RAM, one protect RAM (SRAM Protect in the figure), and one MBE RAM (SRAM MBE in the figure).

The DQ buffer 31 temporarily holds data when the data is written to/read from the data RAM, the boot RAM, the protect RAM, or the MBE RAM. As described above, the DQ buffer 31 can transfer and receive data to and from the ECC buffer 21 via the ECC bus. Furthermore, the DQ buffer 31 can transfer and receive data to and from the interface unit 40 using a RAM/Register bus with a bus width of, for example 64 bits. Like the page buffer 12, the DQ buffer 31 includes an area in which main data is held and an area in which parities and the like are held.

The boot RAM temporarily holds, for example, a boot code required to start-up the memory system 1. The boot RAM has a capacity of, for example, 1 Kbytes. The protect RAM holds protect information, that is, for example, information (for example, block addresses) on protected blocks (in the NAND flash memory 2, for example, blocks in which data write, data read, or data erase is limited). MBE RAM holds MBE information, that is, information (for example, blocks addresses) on blocks to be erased when MBE is performed. The data RAM temporarily holds data (main data and parities) other than the boot code, protect information, and MBE information. The capacity of the data RAM is, for example, 2 Kbytes, and the memory system has two data RAMs. Each of the data RAMs includes a memory cell array 32, a sense amplifier 33, and a row decoder 34.

The memory cell array 32 includes a plurality of SRAM cells capable of holding data. Each of the SRAM cells is connected to a word line and a bit line. The sense amplifier 33 functions as a load when the data in the DQ buffer 31 is written to any of the SRAM cells. The row decoder 34 selects any of the word lines in the memory cell array 32.

### <<Interface Unit 40>>

Now, still referring to FIG. 1, the interface unit 40 will be described. As shown in FIG. 1, the interface unit 40 includes a plurality of (in the present embodiment, two) burst buffers 41 and 42 and an interface 43.

The interface 43 can be connected to host apparatus located outside the memory system 1 to output and receive various signals such as data, control signals, and addresses Add to and from the host apparatus. Examples of the control signal include a chip enable signal/CE that serves to enable the entire memory system 1, an address valid signal/AVD that allows an address to be latched, a burst read clock CLK, a write enable signal/WE that serves to enable a write operation, and an output/enable signal/OE that serves to enable data to be output to an external apparatus. The MBE command is also accepted by the interface 43.

The interface 43 is connected to the burst buffer 41 and 42 by, for example, a DIN/DOUT bus with a bus width of 16 bits. The interface 43 transfers control signals related to a data read request, a data load request, a data write request, a data program request, and an MBE request, to the access controller 50. During data reading, the interface 43 outputs the data in the burst buffers 41 and 42 to the host apparatus. Furthermore, during data writing, the interface 43 transfers data provided by the host apparatus to the burst buffers 41 and 42. Moreover, during MBE, the interface 43 transfers an MBE request provided by the host apparatus and a block address indicative of an erase target blocks, to the bust buffers 41 and 42.

The burst buffers 41 and 42 can transfer and receive data to and from the DQ buffer 31 and the controller unit 4 via the RAM/Register bus. Furthermore, the burst buffers 41 and 42 can transfer and receive data to and from the interface 43 via the DIN/DOUT bus. The burst buffers 41 and 42 temporarily hold data provided by the host apparatus via the interface 43 or data provided by the DQ buffer 31.

### <<Access Controller 50>>

The access controller 50 receives signals and addresses from the interface 43. The access controller 50 controls SRAM 30 and the controller unit 4 so that SRAM 30 and the controller unit 4 perform operations that meet requests from the host apparatus.

More specifically, in response to a request from the host apparatus, the access controller 50 activates one of SRAM 30 and a register 60 for the controller 4 described below. The access controller 50 then issues a data write command or a data read command (Write/Read) for SRAM 30 or a write command or a read command (Write/Read; these commands are hereinafter referred to as a register write command and a register read command) for the register 60. The above-described control allows SRAM 30 and the controller unit 4 to start operation. Similarly, the access controller 50 issues an MBE command during MBE.

### <Controller Unit 4>

Now, still referring to FIG. 1, the controller unit 4 will be described. The controller unit 4 controls the operation of the NAND flash memory 2 and the RAM unit 3. That is, the controller unit 4 provides a function to control the operation of the memory system 1 as a whole. As shown in FIG. 1, the controller unit 4 includes the register 60, a command user interface 61, a state machine 62, an address/command generator 63, and an address/timing generator 64.

The register 60 is configured to be set the operational status of a function. That is, the operational status of the function is set in the register 60 in accordance with a register write command or a register read command. More specifically, for example, for data loading, a load command is set in the register 60. For data programming, a program command is set in the register 60. For MBE, an MBE command is set in the register 60.

The command user interface 61 recognizes that a function execution command is provided to the memory system 1 when a predetermined command is set in the register 60. Then, the command user interface 61 outputs an internal command signal (Command) to the state machine 62.

The state machine 62 controls a sequence operation inside the memory system 1 based on an internal command signal provided by the command user interface 61. The state machine 62 supports many functions such as loading, program, and erase. The state machine 62 controls the operation of NAND flash memory 2 and the RAM unit 3. As described above, the loading is an operation of reading data from the NAND flash memory 2 and outputting the data to SRAM 30. The program is an operation of storing RAM data in the NAND flash memory 2. The erase is an operation of removing data in the NAND flash memory 2.

The address/command generator 63 controls the operation of the NAND flash memory 2 base on the control performed by the state machine 62. More specifically, the address/command generator 63 generates and outputs addresses, commands (Program/Load/Erase), and the like to the NAND flash memory 2. The address/command generator 63 outputs the addresses and commands in synchronism with an internal clock ACLK generated by the oscillator 16.

The address/timing generator 64 controls the operation of the RAM unit 3 based on the control performed by the state machine 62. More specifically, the address/timing generator 64 issues and outputs addresses and commands required for the RAM unit 3, to the access controller 50 and the ECC engine 22.

### <Details of Configuration of the NAND Flash Memory 2>

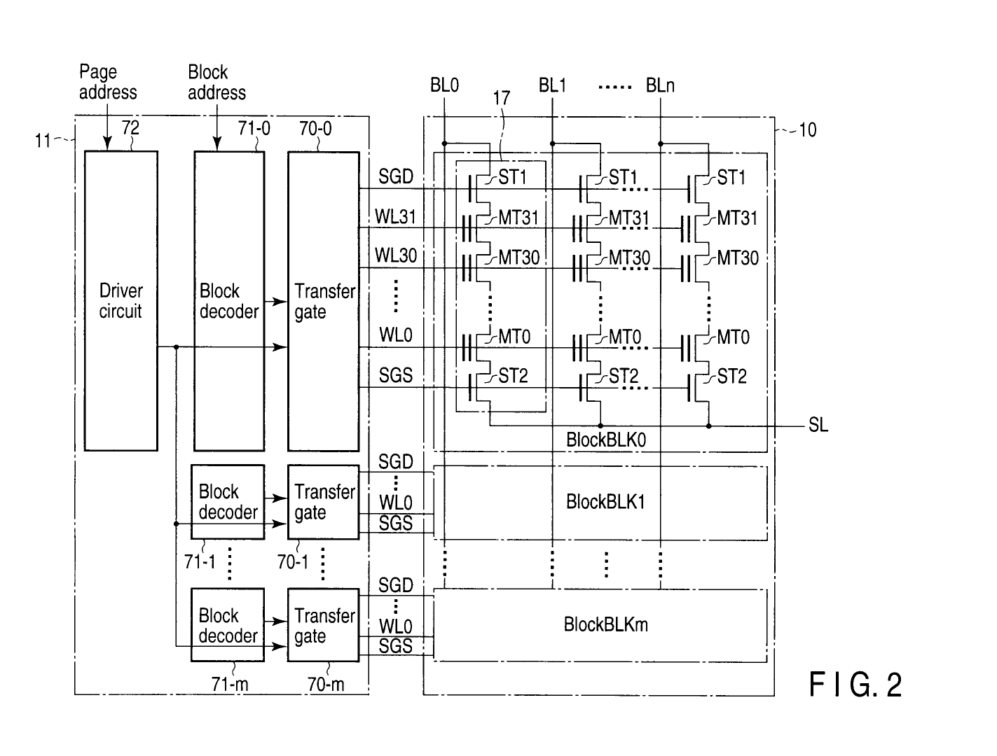

Now, the configuration of the NAND flash memory 2 will be described in detail particularly with the memory cell array 10 and the row decoder 11 focused on. FIG. 2 is a circuit diagram of the memory cell array 10 and the row decoder 11.

### <<Details of the Memory Cell Array 2>>

First, the memory cell array 2 will be described. As shown in FIG. 2, the memory cell array 10 includes (m+1) (m+1 is a natural number of at least 2) blocks BLK0 to BLKm. The blocks BLK0 to BLKm are hereinafter simply referred to as the blocks BLK if the blocks are not distinguished from one another. Each of the blocks BLK includes a plurality of, (n+1) (n+1 is a natural number of at least 2) memory cell units 17.

Each of the memory cell units 17 includes, for example, 32 memory cell transistors MT0 to MT31 and selection transistors ST1 and ST2. The memory cell transistors MT0 to MT31 are hereinafter simply referred to as the memory cell transistors MT if the memory cell transistors are not distinguished from one another. The memory cell transistor MT has a stacked gate structure with a charge accumulation layer (for example, a floating gate) formed on a semiconductor substrate with a gate insulating film interposed therebetween and a control gate formed on the charge accumulation layer with an integrate insulating film interposed therebetween. The number of memory cell transistors MT is not limited to 32 but may be 8, 16, 64, 128, 256, or the like; the number is not particularly limited. Furthermore, the memory cell transistors MT may have a MONOS (Metal Oxide Nitride Oxide Silicon) structure in which an insulating film such as a nitride film is used as a charge accumulation layer so that the nitride film traps electrons.

The adjacent memory cell transistors MT share a source and a drain. The memory cell transistors MT are arranged such that current paths in the memory cell transistors MT are connected together in series between selection transistors ST1 and ST2. A drain of one of the series connected memory cell transistors MT located at one end of the arrangement of the memory cell transistors MT is connected to a source of the selection transistor ST1. A source of one of the series connected memory cell transistors MT located at the other end is connected to a drain of the selection transistor ST2.

Control gates of the memory cell transistors MT in the same row are all connected to one of word lines WL0 to WL31. Furthermore, gates of the selection transistors ST1 in the same row are all connected to a selection gate lines SGD. Gates of the selection transistors ST2 in the same row are all connected to a selection gate lines SGS. For simplification, the word lines WL0 to WL31 are hereinafter sometimes simply referred to as the word lines WL.

Furthermore, a drain of the selection transistor ST1 is connected to one of bit lines BL0 to BLn. The bit lines BL0 to BLn connect a plurality of memory cell units 17 together among a plurality of blocks BLK. The bit lines BL0 to BLn are simply referred to as the bit lines BL if the bit lines are not distinguished from one another.

Sources of the selection transistors ST2 are connected to a source line SL. The source line SL is shared within the memory cell array 10.

In the above-described configuration, data is written to or read simultaneously from the plurality of memory cell transistors MT connected to the same word line WL. This unit is called a page. Moreover, data is erased simultaneously from the plurality of memory cell units 17 in the same row. This unit is a block.

Each of the memory cell transistors MT can hold one-bit data, for example, in response to a change in the threshold voltage of the transistor associated with the amount of electrons injected into the floating gate. The control of the threshold voltage may be divided into fractions so that each of the memory cell transistors MT holds at least 2 bits.

Furthermore, in each of the blocks BLK, certain memory cell units 17 are used to hold information for error corrections (parities and the like). The remaining memory cell units 17 are used to hold net user data.

Moreover, one of the blocks BLK (in the present embodiment, the block BLKm) is used to hold system information on the NAND flash memory 2. An example of the system information is bad-block information. The bad-block information is information on the blocks BLK that have been set to be unusable owing to certain defects, and is, for example, the block addresses of these blocks BLK. The block BLKm is hereinafter sometimes referred to as a ROM fuse block.

### <<Details of the Row Decoder 11>>

Now, still referring to FIG. 2, the row decoder 11 will be described. As shown in FIG. 2, the row decoder 11 includes transfer gates 70-0 to 70-m, block decoders 71-0 to 71-m, and a driver circuit 72.

The driver circuit 72 is provided so as to be shared by the blocks BLK0 to BLKm. The driver circuit 72 decodes page addresses and supplies voltages to be applied to the word lines WL0 to WL31 and the selection gate lines SGD and SGS, to the transfer gates 70-0 to 70-m.

Each of the block decoders 71-0 to 71-m is provided in association with the blocks BLK0 to BLKm. In other words, the block decoders 71-0 to 71-m are provided in association with the transfer gates 70-0 to 70-m, respectively. The block decoders 71-0 to 71-m decode block addresses to turn on or off the corresponding transfer gates 70-0 to 70-m, respectively.

Each of the transfer gates 70-0 to 70-m is also provided in association with the blocks BLK0 to BLKm. Each of the transfer gates 70-0 to 70-m transfers voltages provided by the driver circuit 72 to the word lines WL and selection gate lines SGD and SGS in the corresponding block BLK.

That is, the block decoder 71 selects one of the transfer gates 70-0 to 70-m, and voltages generated by the driver circuit 72 are transferred to the block BLK by the selected one of the transfer gates 70-0 to 70-m. What voltage is applied to which of the word lines WL (that is, which of the word lines WL is selected) is determined by the driver circuit 72. The transfer gates 70-0 to 70-m are also hereinafter sometimes simply referred to as the transfer gates 70.

### <<Details of the Transfer Gate 70 and the Block Decoder 71>>

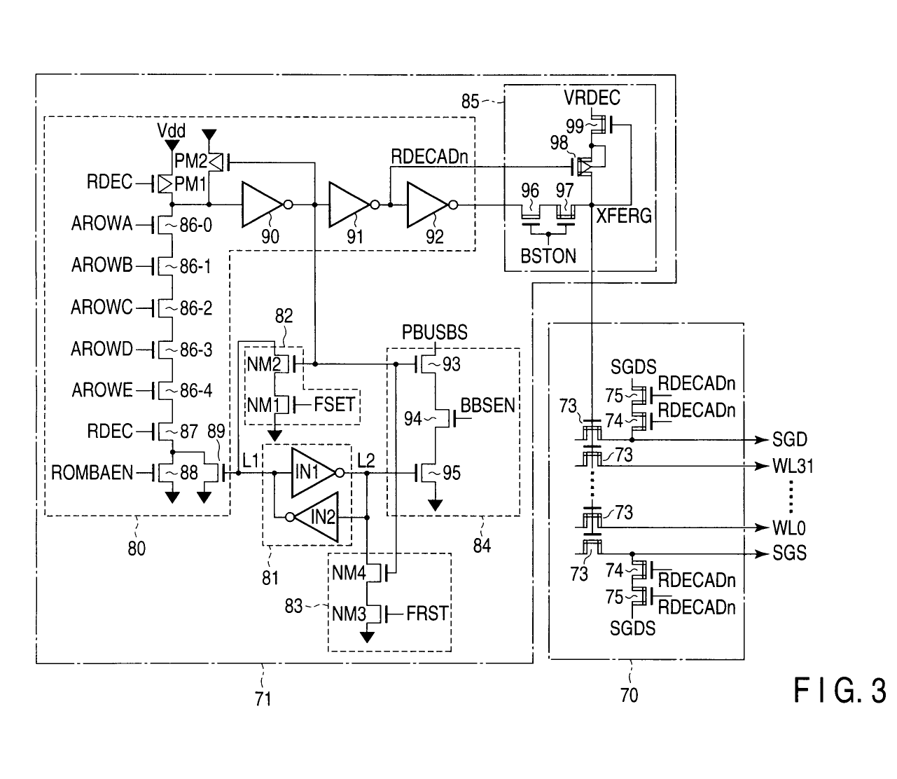

Now, the transfer gate 70 and the block decoder 71 will be described with reference to FIG. 3. FIG. 3 is a circuit diagram of the transfer gate 70 and the block decoder 71.

First, the transfer gate 70 will be described. As shown in FIG. 3, the transfer gate 70 includes MOS transistors 73 to 75.

The MOS transistors 73 are enhancement-type re-channel MOS transistors of a high withstand voltage type provided in association with the selection gate lines SGD and SGS and the word lines WL0 to WL31, respectively. One end of the current path in the MOS transistor 73 is connected to the corresponding one of the selection gate lines SGD and SGS and the word lines WL0 to WL31. A voltage is supplied to the other end of the current path by the driver circuit 72. The gates of the MOS transistors 73 in the same transfer gate 70 are connected together and to a node XFERG in the corresponding block decoder 71. The node XFERG provides a signal RDECAD to the MOS transistors 73. The signal RDECAD is at an “H” level if the corresponding block BLK is selected or at an “L” level if the corresponding block BLK is unselected.

The MOS transistors 74 and 75 are depression-type n-channel MOS transistors of a high withstand voltage type and include current paths connected together in series. A source of the MOS transistor 74 is connected to the selection gate line SGD or SGS. A drain of the MOS transistor 75 is connected to a node SGDS. A signal RDECADn is input to a gate of the MOS transistor 75.

The signal RDECADn is an inversion signal of the signal RDECAD. Thus, the transfer gate 70 corresponding to the selected block transfers a voltage from the driver circuit 72, through the MOS transistor 73. The transfer gates 70 corresponding to the unselected blocks transfer a voltage from the node SGDS through the MOS transistors 74 and 75.

Now, the block decoder 71 will be described. As shown in FIG. 3, the block decoder 71 generally includes a decode circuit 80, a holding circuit 81, a set circuit 82, a reset circuit 83, a read circuit 84, and a level shifter 85.

The decode circuit 80 includes enhancement-type p-channel MOS transistors PM1 and PM2 of a low withstand voltage type and enhancement-type n-channel MOS transistors 86-0 to 86-4 and 87 to 89 of a low withstand voltage type all offering a withstand voltage lower than that of the MOS transistors of the high withstand voltage type, and inverters 90 to 92. A source of each of the MOS transistors PM1 and PM2 is provided with a power supply voltage Vdd. Drains of the MOS transistors PM1 and PM2 are connected together. A gate of the MOS transistor PM1 is provided with a signal RDEC. Sources of the MOS transistors 88 and 89 are grounded. Drains of the MOS transistor 88 and 89 are connected together. A gate of the MOS transistor 88 is provided with a signal ROMBAEN. The signal ROMBAEN is normally at the “L” level. Current paths in the MOS transistors 86-0 to 86-4 and 87 are connected together in series between the drains of the MOS transistors PM1 and PM2 and the drains of the MOS transistors 88 and 89. Signals ARROWA to ARROWE and RDEC are input to the MOS transistors 86-0 to 86-4 and 87, respectively. If the block decoder 71 corresponds to the selected block, all the signals ARROWA to ARROWS are at the “H” level. If the block decoder 71 fails to correspond to the selected block, at least one of the signals ARROWA to ARROWS is at the “L” level. The signal RDEC changes to the “H” level when the signals ARROWA to ARROWS are input. The signal RDEC is at the “L” level before the signals ARROWA to ARROWS are input. The inverters 90 to 92 are connected together in series. An input node of the inverter 90 is connected to sources of the MOS transistors PM1 and PM2 and a drain of the MOS transistor 86-0. An output node of the inverter 90 and an input node of the inverter 91 are connected to a gate of the MOS transistor PM2. Furthermore, an output from the inverter 91 is a signal RDECADn.

The holding circuit 81 is a latch circuit including inverters IN1 and IN2. An input node of the inverter IN1 and an output node of the inverter IN2 are connected to a node L1. An input node of the inverter IN2 and an output node of the inverter IN1 are connected to a node L2. The node L1 is connected to a gate of the MOS transistor 89. The holding circuit 81 holds bad-block information during a data load operation, a data programming operation, and a normal erase operation (an erase operation with one erase target block). Bad-block information is stored in the holding circuit 81 at a timing, for example, when the memory system 1 is powered on. That is, upon power-on, based on an instruction from the controller unit 4, bad-block information is read from the ROM fuse block (block BLKm). More specifically, in the holding circuits 81 in all the block decoders 71, a signal FRST is set to the “H” level to set the node L1 to the “H” level. Subsequently, with only the block decoder 71 corresponding to a bad block selected, a signal FSET is set to the “H” level. As a result, in the block decoder 71, the node L1 is changed to the “L” level. Furthermore, during an MBE operation, the holding circuit 81 holds the above-described MBE information stored in SRAM 30. The MBE operation will be described below in detail. That is, depending on the information held in the holding circuit 81, the potential of the node L1 is set to the “H” level or the “L” level.

The set circuit 82 includes enhancement-type n-channel MOS transistors NM1 and NM2 of a low withstand voltage type. A source of the MOS transistor NM1 is grounded. The signal FSET is input to a gate of the MOS transistor NM1. A source of the MOS transistor NM2 is connected to a drain of the MOS transistor NM1. A drain of the MOS transistor NM1 is connected to the node L1. A gate of the MOS transistor NM1 is connected to an output node of the inverter 90.

The reset circuit 83 includes enhancement-type re-channel MOS transistors NM3 and NM4 of a low withstand voltage type. A source of the MOS transistor NM3 is grounded. The signal FRST is input to a gate of the MOS transistor NM3. A source of the MOS transistor NM4 is connected to a drain of the MOS transistor NM3. A drain of the MOS transistor NM3 is connected to the node L2. A gate of the MOS transistor NM3 is connected to the output node of the inverter 90.

The read circuit 84 includes enhancement-type re-channel MOS transistors 93 to 95 of a low withstand voltage type. The MOS transistors 93 to 95 includes current paths sequentially connected together in series between a node PBUSBS and a ground potential node. A gate of the MOS transistor 93 is connected to the output node of the inverter 90. A signal BBSEN is input to a gate of the MOS transistor 94. A gate of the MOS transistor 95 is connected to the node L2. The nodes PBUSBS in all the block decoders 71 are connected together.

The level shifter 85 includes MOS transistors 96 to 99. The MOS transistor 96 is a depression-type re-channel MOS transistor of a low withstand voltage type. A drain of the MOS transistor 96 is connected to the output node of the inverter 92. A signal BSTON is provided to a gate of the MOS transistor 96. The signal BSTON is at the “H” level during block address decoding. The MOS transistor 97 is a depression-type n-channel MOS transistor offering a higher withstand voltage than the MOS transistor 96. A drain of the MOS transistor 97 is connected to a source of the MOS transistor 96. A source of the MOS transistor 97 is connected to a node XFERG. The signal BSTON is provided to a gate of the MOS transistor 97. The MOS transistor 98 is an enhancement-type p-channel MOS transistor of the above-described high withstand voltage type. A drain of the MOS transistor 98 is connected to the node XFERG. A source of the MOS transistor 98 is connected to a back gate. A signal RDECADn is provided to a gate of the MOS transistor 98. The MOS transistor 99 is a depression-type n-channel MOS transistor of the above-described high withstand voltage type. A signal VRDEC is provided to a drain of the MOS transistor 99. A source of the MOS transistor 99 is connected to a source of the MOS transistor 98. A gate of the MOS transistor 99 is connected to the node XFERG. The voltage VRDEC has values required for data write, data read, and data erase. Furthermore, the node XFERG is connected to a gate of the MOS transistor 73 in the corresponding transfer gate 70. Thus, the “H” level potential of the signal RDECAD has a value corresponding to the potential VRDEC.

In the block decoder 71 configured as described above, when the corresponding block BLK matches the block address, the MOS transistors 86-0 to 86-4 are turned on to set the signal RDECADn to the “L” level (RDECAD=“H”). As a result, the node XFERG is provided with the voltage VRDEC. Thus, in the corresponding transfer gate 70, the MOS transistor 73 is turned on.

On the other hand, if the block address fails to match, at least one of the MOS transistors 86-0 to 86-4 is turned off. The signal RDECADn is set to the “H” level. As a result, in the corresponding transfer gate 70, the MOS transistor 73 is turned off.

Furthermore, regardless of the block address, the MOS transistor 89 is turned off if the holding circuit 81 sets the node L1 to the “L” level. As a result, the signal RDECADn is set to the “H” level. In the corresponding transfer gate 70, the MOS transistor 73 is turned off.

### <Operation of the Memory System 1>

Now, the operation of the memory system 1 configured as described will be generally described in brief. As described above, in the memory system 1 according to the present embodiment, data is transmitted between the NAND flash memory 2 and the host apparatus via SRAM 30.

That is, if the host apparatus allows the NAND flash memory 2 in the memory system 1 to store data, first, the data is temporarily stored in the data RAM or the boot RAM in accordance with a write command provided by the host apparatus and address in SRAM 30. Thereafter, in accordance with a program command and address of the NAND flash memory 2 provided by the host apparatus, the data stored in the SRAM 30 is programmed in the NAND flash memory in unit of page.

Furthermore, if the host apparatus reads data in the NAND flash memory 2, first, in accordance with a load command, address of the NAND flash memory 2, and address of the SRAM 30 provided by the host apparatus, the data is read from the NAND flash memory 2 and temporarily stored in the data RAM or the boot RAM. Thereafter, in accordance with a read command and address of the SRAM 30 provided by the host apparatus, data in the data RAM or boot RAM is read to the host apparatus via the interface unit 40.

An example of an operational procedure for loading will be described below in brief.

First, the host apparatus inputs the addresses of the NAND flash memory 2 and SRAM and the load command to the interface unit 40.

Then, in the memory system 1, the access controller 50 sets the addresses and command in the register 60. The command user interface 61 senses that the command has been set in the register 60, and then issues an internal command signal. For loading, the load command is issued.

Upon receiving the load command from the user interface 61, the state machine 62 is started. The state machine 62 performs a required initialization operation on each circuit block. The state machine 62 then requests the address/command generator 63 to issue a sense command to the NAND flash memory 2.

Then, the address/command generator 63 issues a sense command to the sequencer 14 to sense data for the addresses set in the register 60.

Upon receiving the sense command from the address/command generator 63, the sequencer 14 is started. The sequencer 14 performs a required initialization operation on the NAND flash memory 2 and then performs a sense operation on the specified addresses. That is, the sequencer controllably allows the voltage supply 13, the row decoder 11, a sense amplifier (not shown in the drawings), and the page buffer 12 to store the sense data in the page buffer 12. Thereafter, the sequencer 14 notifies the state machine 62 that the sense operation has been finished.

Then, the state machine 62 instructs the address/command generation circuit 63 to issue a transfer command to the NAND flash memory 2. The transfer command is an instruction for transferring data from the NAND flash memory 2 to the RAM unit 3. In response to this instruction, the address/command generation circuit 63 outputs and issues the transfer command to the sequencer 14.

Upon receiving the transfer command, the sequencer 14 sets the page buffer 12 to be able to transfer data. Then, in accordance with the control performed by the sequencer 14, the data in the page buffer 12 is transferred to the ECC buffer 21 via the NAND bus.

Moreover, the state machine 62 issues an error correction start control signal to the ECC unit 20. In response to the signal, the ECC unit 20 executes an ECC process. Then, the data subjected to the ECC process is transferred from the ECC unit 20 to the DQ buffer 31 via the ECC bus.

Subsequently, in accordance with an instruction from the access controller 50, the data in the DQ buffer 31 is written to the memory cell array 32 in SRAM 30.

Thus, the data loading is completed. Thereafter, the host apparatus issues a read command via the interface unit 40 to read the data written to the memory cell array 32.

### <MBE Operation>

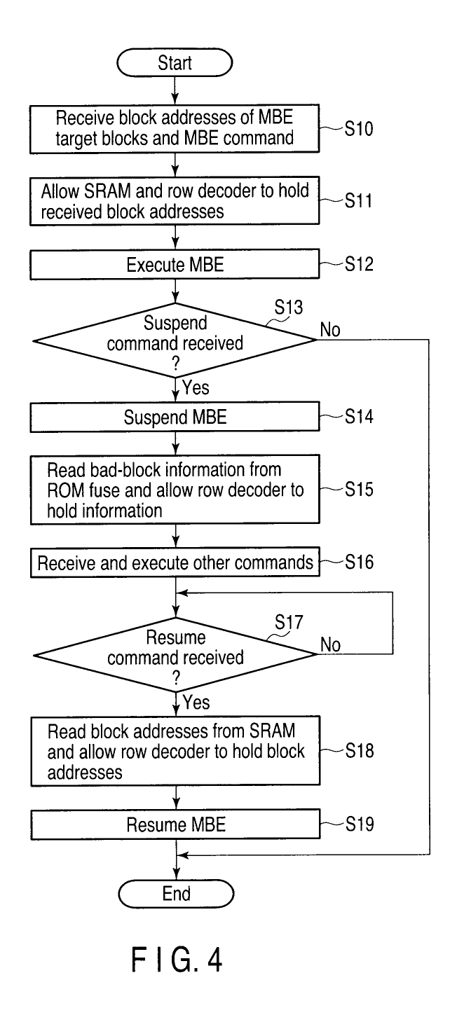

Now, the MBE operation will be described together with the operation of the block decoder 71 in the row decoder 11. FIG. 4 is a flowchart of the MBE operation in the memory system 1 according to the present embodiment.

As shown in FIG. 4, first, the memory system 1 receives the block addresses (hereinafter referred to as MBE addresses) of MBE target blocks and the MBE command from the host apparatus (step S10). The block addresses and the MBE command are accepted by the interface 43 and supplied to the access controller 50. The access controller 50 allows the register 60 in the controller unit 60 to hold the command and block addresses. Furthermore, the command user interface 61 senses that the command and the block addresses are held in the register 60, and thus issues an internal command signal (MBE command). Then, the state machine 62 receives the MBE command from the command user interface 61 and is thus started.

Then, the MBE address received in step S10 is held in SRAM 30 and the row decoder 11 in the NAND flash memory 2 (step S11). That is, the state machine 62 in the controller unit 5 instructs the address/timing generator 64 to write the MBE addresses in the register to SRAM 30. Based on the instruction, the address/timing generator 64 instructs the access controller 50 to perform a write operation. The access controller 50 issues a write command to SRAM 30. Furthermore, the register 60 transfers the MBE addresses to the DQ buffer in SRAM 30. Thus, the MBE addresses are written to MBE RAM in SRAM 30.

Moreover, the state machine 62 requests the address/command generator 63 to set the MBE addresses in the row decoder 11 in the NAND flash memory 2 to erase data. Then, the address/command generator 63 issues a command to the sequencer 14 to allow the sequencer 14 to set the MBE addresses in the row decoder 11.

When the sequencer 14 receives the command, the block decoder 71 in the row decoder 11 in the NAND flash memory 2 performs the following operation. That is, in all the block decoders 71, the signal FSET is set to the “H” level. Furthermore, all of the signals ARROWA to ARROWE, RDEC, and ROMBAEN are set to “H” level. Thus, in all the block decoders 71, the output node of the inverter 90 is set to the “H” level. As a result, the MOS transistor NM2 is turned on. Moreover, the signal FSET also turns on the MOS transistor NM1, setting the node L1 to the “L” level (this operation is expressed as “setting the holding circuit 81”). As a result, all the blocks BLK are set to be apparently bad blocks.

Subsequently, only in the block decoders 71 in the MBE target blocks BLK, the node L1 is set to the “H” level (this operation is expressed as “resetting the holding circuit). That is, the MBE addresses are input to the block decoders 71. As a result, in the block decoders 71 corresponding to the MBE target blocks BLK, all of the signals ARROWA to ARROWE are set to the “H” level. Furthermore, the signals RDEC and ROMBAEN are set to the “H” level. Then, the signal FRST=“H” for all the blocks. As a result, in the block decoders 71 corresponding to the MBE target blocks BLK, the output node of the inverter 90 is set to the “H” level. The MOS transistors NM4 and NM3 are turned on. Thus, the node L2 is set to the “L” level, and the node L1 is set to the “H” LEVEL. On the other hand, in the block decoders 71 corresponding to the non-MBE-targets, any of the signals ARROWA to ARROWS is set to the “L” level. Thus, the output node of the inverter 90 remains at the “L” level. Thus, the MOS transistor NM4 remains off, the node L2 remains at the “H” level, and the node H1 remains at the “L” level.

After step S11, in accordance with control performed by the sequencer 14, data is erased simultaneously from the plurality of blocks BLK (step S12). That is, in the block decoders 71 corresponding to the MBE target blocks BLK, the signal RDECADn=“L”. All the MOS transistors 73 in the corresponding transfer gate 70 are turned on. Furthermore, the driver circuit 72 generates 0 V as a voltage to be applied to the word lines WL0 to WL31. As a result, the potential of the word lines WL to WL31 in the MBE target blocks BLK is set to 0 V. Additionally, the row decoder 11 generates and applies a positive high voltage VERA (for example, 20 V) to a well region in which the memory cell array 10 is formed. As a result, electrons are drawn out from the charge accumulation layer in the memory cell transistor MT to erase the data.

On the other hand, in the block decoders 71 corresponding to the non-MBE-targets, the signal RDECADn=“H”. The MOS transistors 73 in the corresponding transfer gate 70 are all turned off. Thus, the transfer gate 70 avoids transferring 0 V. Thus, the word lines WL0 to WL31 are brought into an electrically floating state, and the potential of the word lines WL0 to WL31 increases substantially to VERA. As a result, in the non-MBE-target blocks, no data is erased.

Unless a suspend command is received from the host apparatus during data erase (step S13, NO), data erase is continued, with the MBE operation terminated. The suspend command allows data erase to be temporarily stopped so that the memory system 1 can receive other commands. Upon receiving a resume command after the suspend command, the memory system 1 in which the data erase is temporarily stopped can resume the MBE operation.

When the memory system 1 receives the suspend command (YES in step S13), the state machine 62 and address/command generator 63 in the controller unit 4 instruct the NAND flash memory 2 to suspend the MBE. In response to the instruction, the sequencer 14 suspends the MBE operation (step S14). The sequencer 14 stops applying voltages to the word lines WL and the well region.

After step S14, the NAND flash memory 2 needs to be ready for user's commands. Thus, in the NAND flash memory 2, the bad-block information is read from the ROM fuse block (block BLKm) in accordance with control performed by the sequencer 14. The read bad-block information is held in the holding circuit 81 in the block decoder 71 (step S15)

That is, in all the block decoders 71, the signal FRST is set to the “H” level. Thus, the MOS transistor NM3 is turned on. Moreover, in all the block decoders 71, the signals ARROWA to ARROWE, RDEC, and ROMBAEN are set to the “H” level. Thus, the output node of the inverter 90 is set to the “H” level. The MOS transistor NM4 is also turned on. Thus, the node L2 is set to the “L” level, and the node L1 is set to the “H” level. That is, the holding circuit 81 is reset. As a result, all the blocks BLK are set to be apparently good-blocks.

Then, the holding circuit 81 corresponding to a bad block is reset. That is, the address of the bad block is input to the block decoder 71. As a result, in the block decoder 71 corresponding to the bad block, all of the signals ARROWA to ARROWE are set to the “H” level. Furthermore, RDEC and ROMBAEN are set to the “H” level. Then, in the block decoder 71 corresponding to the bad block, the output node of the inverter 90 is set to the “H” level. The MOS transistor NM2 is turned on. On the other hand, in the block decoders 71 not corresponding to the bad block, any of the signals ARROWA to ARROWS is at the “L” level. Thus, the output node of the inverter 90 is set to the “L” level. The MOS transistor NM2 remains off. That is, the node L1 maintains the “H” level. Then, for all the blocks, the signal FSET is set to the “H” level, and the MOS transistor NM1 is turned on. As a result, in the block decoder 71 corresponding to the bad block, the MOS transistors NM1 and NM2 are turned on, and the node L1 is set to the “L” level. That is, the holding circuit 81 is set. Thus, the block BLK corresponding to the bad block is unselected regardless of the block address (that is, the signals ARROWA to ARROWS).

After step S15, the memory system 1 accepts a command (write command or read command) from the host apparatus to perform an operation corresponding to the command (step S16).

After step S16, when the memory system receives a resume command from the host apparatus (step S17, YES), the controller unit 4 reads the MBE addresses from SRAM 30 and sets the MBE addresses in the row decoder 11 in the NAND flash memory 2 (step S18).

That is, the resume command from the host apparatus is stored in the register 60 via the access controller 50. The command user interface 61 then issues the recovery command to the state machine. Upon receiving the recovery command, the state machine 62 first instructs the address/timing generator 64 to allow the access controller 50 to read the MBE addresses from MBE RAM in SRAM 30. In response to this, the access controller 50 instructs SRAM to read the MBE addresses. The MBE addresses read from MBE RAM are stored in the register 60 via the DQ buffer 31. The MBE addresses read in the present step are stored in MBE RAM in step S11.

Subsequently, the state machine 62 and the address/command generator 63 instruct the state machine 14 in the NAND flash memory 2 to set the MBE addresses stored in the register 60, in the row decoder 11 to resume the MBE operation.

In response to the instruction, in the NAND flash memory 2, the MBE addresses are set in the holding circuit 81 in the block decoder 71. The method of setting the MBE addresses in the holding circuit 81 is similar to that in step S11. That is, in all the block decoders 71, with all the blocks BLK selected, the signal FSET is set to the “H” level to set the nodes L1 to the “L” level. Thereafter, with only the MBE target blocks BLK selected, the signal FRST is set to the “H” level. Thus, only in the block decoders 71 corresponding to the MBE target blocks, the node L1 is set to the “H” level.

After step S18, the row decoder 11 applies voltages to the word lines WL0 to WL31 to resume the data erase operation (step S19).

### <Specific Example of the MBE Operation>

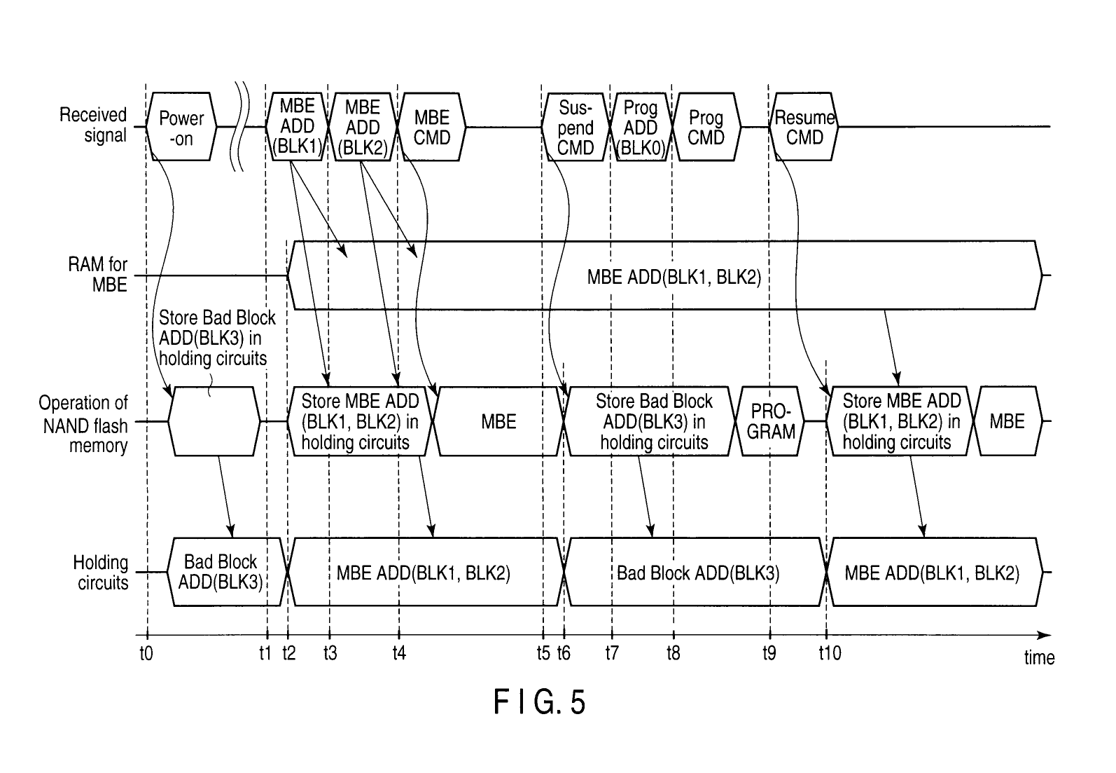

Now, a specific example of the MBE operation will be described with reference to FIG. 5. FIG. 5 is a timing chart showing receive signals received from the user, the contents stored in MBE RAM in SRAM 30, the contents of operations performed by the NAND flash memory 2, and the contents stored in the holding circuit 81 in the block decoder 71. It is assumed below that the block BLK3 is bad block.

As shown in FIG. 5, when the memory system 1 is powered on at time t1, the NAND flash memory 2 reads the bad-block address from the ROM fuse block and allows the holding circuit 81 to hold the bad-block address. It is assumed that at time t1 (and t3), the memory system 1 receives the block addresses (MBE ADD) of the blocks BLK1 and BLK2. Then, the controller unit 4 allows MBE RAM in SRAM 30 to hold the MBE addresses (time t2). That is, all the holding circuits 81 are set to erase the bad-block addresses held in the holding circuit 81. Subsequently, the holding circuits 81 in the block decoders 71-1 and 71-2 are reset.

After the storage of the MBE addresses in the holding circuit 81 is completed, the memory system 1 receives the MBE command (MBE CMD) at time t4. Then, in response to the MBE command, the NAND flash memory 2 carries out MBE.

It is assumed that subsequently, at time t5 during execution of the MBE, the memory system 1 receives the suspend command (Suspend CMD). Then, in response to this, the NAND flash memory 2 suspends the MBE. The NAND flash memory 2 then allows the holding circuit 81 to hold the bad-block address (time t6). That is, the NAND flash memory 2 erases the MBE addresses held in the holding circuits 81, and sets the holding circuit 81 in the block decoder 71-3 based on the bad-block address read from the ROM fuse block.

Thereafter, at time t7, the memory system receives a program address (Prog ADD) and subsequently receives the program command (Prog CMD). Here, it is assumed that the program address corresponds to the block BLK0. Then, once the storage of the bad-block address in the holding circuit 81 is completed, the NAND flash memory 2 programs data for the block BLK0.

It is assumed that thereafter, at time t9, the memory system receives the resume command (Resume CMD). Then, the controller unit 4 reads the MBE addresses from MBE RAM in SRAM 30 and stored the MBE addresses in the holding circuit 81 in the block decoder 71 in the NAND flash memory 2. That is, the NAND flash memory 2 sets all the holding circuits 81 and subsequently resets the block decoders 71-1 and 71-2. Once the storage of the MBE addresses in the holding circuit 81 is completed, the NAND flash memory 2 resumes the MBE.

### <Effects of the Embodiment>

As described above, the semiconductor device and the method for controlling the semiconductor device according to the first embodiment facilitates the suspension and resumption of the MBE, in which a plurality of blocks are erased simultaneously.

According to the method described in Jpn. Pat. Appin. KOKAI Publication No. 2007-179687 discussed in the background section, the row decoder needs to carry the bad-block information in order to allow data read or write to be carried out with the MBE operation suspended. Then, if the row decoder includes only one latch circuit per block, previously held MBE information needs to be erased. That is, the suspension of the MBE operation leads to the loss of information on the block to be erased. As a result, subsequently resuming the MBE operation is difficult.

In this regard, in the configuration according to the present embodiment, when the MBE operation is performed, the MBE information is stored not only in the row decoder 11 but also in SRAM 30. Thus, when the MBE operation is suspended, even if the MBE information is erased from the row decoder, which is then allowed to hold the bad-block information, the MBE operation can be resumed using the MBE information in SRAM 30. This facilitates the suspension and resumption of the MBE operation, allowing the usability of the memory system 1 to be improved.

Furthermore, the memory system 1 originally includes SRAM 30 and can thus perform the above-described operation without increasing the circuit area. Even with an increase in the capacity of the memory cell array 32, a conventional sense amplifier and a conventional row decoder can be used as the sense amplifier 33 and the row decoder 34, the circuit area increases only by a small amount.

Additionally, even compared to the case in which two latch circuits are provided in the block decoder 71 in the row decoder 11 and dedicated to the bad-block information and the MBE information, respectively, the present embodiment substantially reduces the circuit area. The latch circuits (holding circuits 81) are scattered about in the row decoder 11. Thus, an increase in the number of latch circuits significantly affects an increase in circuit area. However, the memory cell array 32 in SRAM 30 is a set of memory cells and is very highly integrated. Thus, even with the need to increase the capacity of the memory cell array 32, a corresponding increase in circuit area can be suppressed to the degree that the increase poses no major problems.

### SECOND EMBODIMENT

Now, a semiconductor device and a method for controlling the semiconductor according to a second embodiment will be described. The present embodiment corresponds to the first embodiment in which the holding circuit 81 is dedicated to holding of MBE information. Only differences from the first embodiment will be described below.

### <Configuration of SRAM 30>

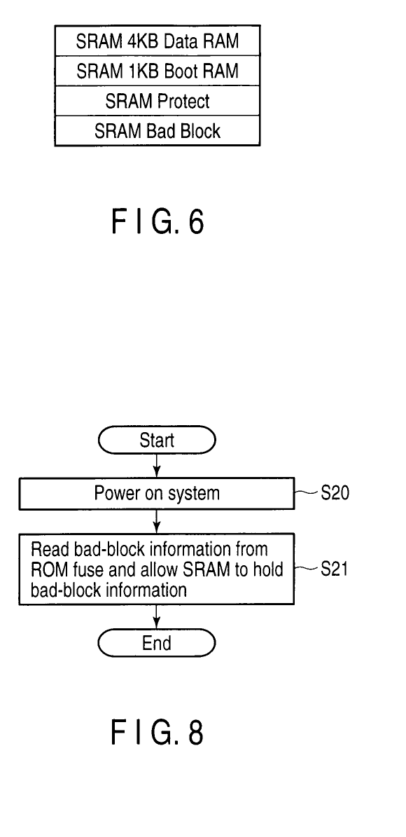

First, SRAM 30 according to the present embodiment will be described with reference to FIG. 6. FIG. 6 is a schematic diagram of a memory cell array in SRAM 30.

As shown in FIG. 6, SRAM 30 corresponds to the configuration in FIG. 1 described in the first embodiment and in which MBE RAM is removed and a bad-block RAM (SRAM Bad Block) is provided. The bad-block RAM is for holding information (for example, block addresses) on blocks BLK (bad blocks) determined by the NAND flash memory 2 to be bad block.

### <Configuration of the Row Decoder 11>

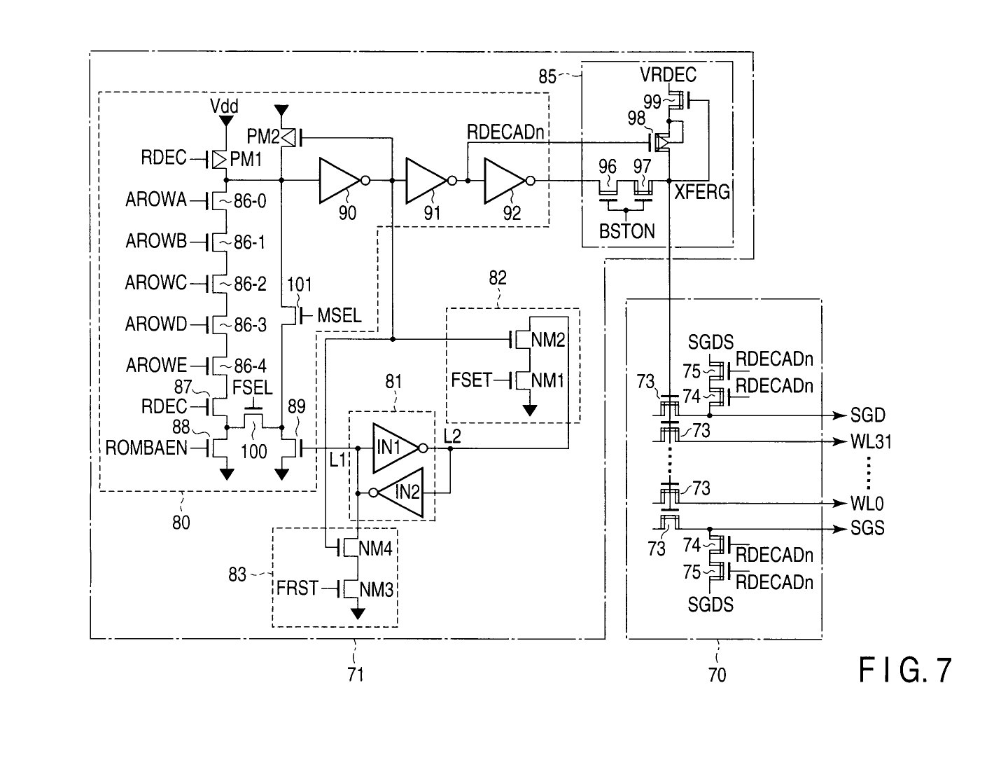

Now, a block decoder 71 in a NAND flash memory 2 according to the present embodiment will be described. FIG. 7 is a circuit diagram of a transfer gate 70 and the block decoder 71. The transfer gate 70 and a driver circuit 72 are similar to those in the first embodiment. The following description focuses on differences from the configuration in FIG. 3 described in the first embodiment.

As shown in FIG. 7, the block decoder 71 according to the present embodiment has the same configuration as that described with reference to FIG. 3 except that the read circuit 84 in FIG. 3 is removed. In the present embodiment, a drain of a MOS transistor MN2 in a set circuit 82 is connected to a node L2. A drain of a MOS transistor NM4 in a reset circuit 83 is connected to a node L1.

Moreover, two switch elements are added to a decoder circuit 80. The two switch elements are, for example, enhancement-type n-channel MOS transistors 100 and 101 of a low withstand voltage type. The MOS transistor 100 includes a current path one end of which is connected to a source of a MOS transistor 87 and the other end of which is connected to a drain of a MOS transistor 89. A signal FSEL is input to a gate of the MOS transistor 100. Furthermore, the MOS transistor 101 includes a current path one end of which is connected to an input node of an inverter 90 and the other end of which is connected to the drain of the MOS transistor 89. A signal MSEL is input to a gate of the MOS transistor 101.

A holding circuit 81 according to the present embodiment is dedicated to holding of MBE information at least during normal operation. Thus, setting data in the holding circuit 81 so as to set the node L1 to the “L” level is hereinafter referred to as “resetting” of the holding circuit 81. Setting data in the holding circuit 81 so as to set the node L1 to the “L” level is hereinafter referred to as “resetting” of the holding circuit 81. Setting data in the holding circuit 81 so as to set the node L1 to the “H” level is hereinafter referred to as “setting” of the holding circuit 81. That is, the relationship between setting and resetting of the holding circuit 81 is opposite to that in the first embodiment. The remaining part of the configuration is similar to that in the first embodiment. Signals FSET and FRST are common to all the blocks.

### <Operation of the Memory System 1 Upon Power-on>

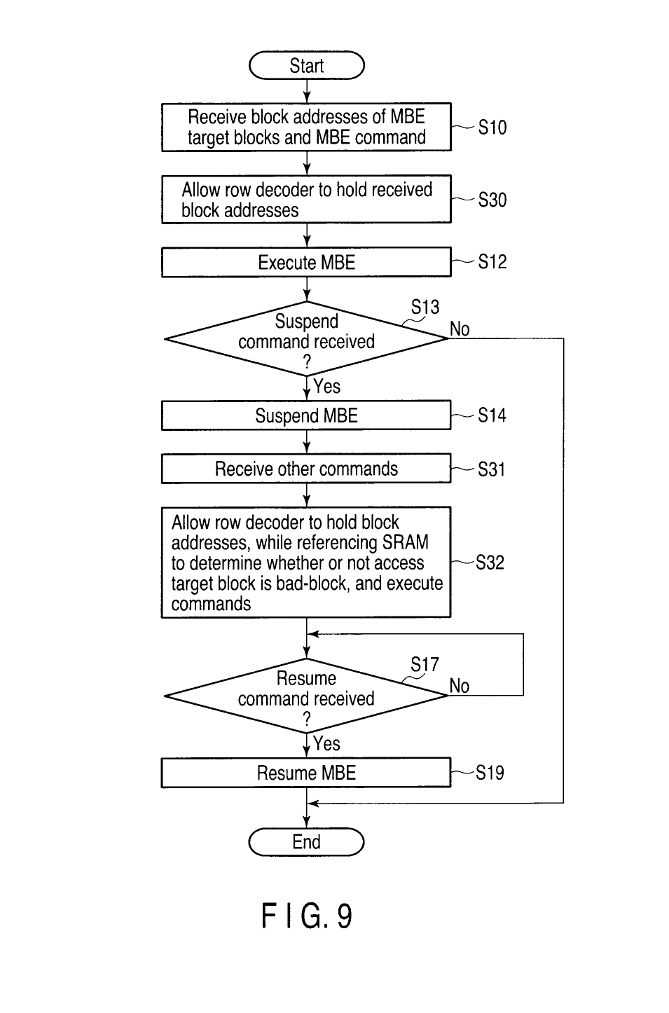

Now, the operation of a memory system 1 performed upon power-on will be described with reference to FIG. 8. FIG. 8 is a flowchart showing the flow of the operation performed upon power-on.

As shown in FIG. 8, when the memory system 1 is powered on (step S20), a controller unit 4 instructs the NAND flash memory 2 to read bad-block information (bad-block address) from a ROM fuse block (block BLKm). The controller unit 4 then allows a bad-block RAM in SRAM 30 to hold the read bad-block information (step S21).

### <MBE Operation>

Now, an MBE operation according to the present embodiment will be described together with the operation of the block decoder 71 in the row decoder 11. FIG. 9 is a flowchart of the MBE operation according to the present embodiment.

As shown in FIG. 9, after step S10 described in the first embodiment, the controller unit 4 allows the row decoder 11 in the NAND flash memory 2, instead of SRAM 30, to hold the received MBE addresses (step S30).

That is, in all the block decoders 71, with all of signals ARROWA to ARROWS, RDEC, and ROMBAEN set to the “H” level, the signal FRST is set to the “H” level. Thus, the MOS transistors NM3 and NM4 are turned on to set the node L1 to the “L” level. That is, the holding circuit 81 is reset. As a result, all the blocks BLK are set to be apparently bad block. Subsequently, in the block decoders 71 corresponding to MBE target blocks, the signals ARROWA to ARROWS, RDEC, and ROMBAEN are set to the “H” level to select a particular block, the signal FSET is set to the “H” level. As a result, the node L2 is set to the “L” level, and the node L1 is set to the “H” level. That is, the holding circuit 81 is set.

Furthermore, for the MBE operation, in all the block decoders 71, a state machine 14 sets a signal MSEL to the “H” level and sets the signal FSEL to the “L” level. Thus, the block BLK is not selected based on the signals ARROWA to ARROWS but based on the information in the holding circuit 81.

After step S30, data is erased from a plurality of blocks BLK in a batch (step S12). When the memory system receives a suspend command from the host apparatus during data erase (step S13, YES), the NAND flash memory 2 suspends the MBE operation (step S14). At this time, in the block decoder 71, the signal MSEL is set to the “L” level. Thus, a signal RDECADn is not determined based on the information held in the holding circuit 81 but based on the signals ARROWA to ARROWS and ROMBAEN.

Then, when the memory system accepts a command from the host apparatus (step S31), the NAND flash memory 2 performs an operation corresponding to the command (step S32). The command and addresses received from the user are stored in a register 60 in the controller unit 4 via an access controller 50. Then, a state machine 62 determines whether or not each of the addresses corresponds to a bad block, based on bad-block information held in the bad-block RAM in SRAM. The bad-block information is stored in RAM 30 in step S30.

After step S32, when the memory system receives a resume command from the host apparatus (step S17, YES), the controller unit 4 instructs the NAND flash memory 2 to resume the MBE operation.

In response to the resume command, the NAND flash memory 2 resumes the MBE operation (step S19). At this time, in the block decoder 71, the signal MSEL is set to the “H” level. Thus, appropriate ones of the blocks BLK are selected based on the MBE addresses held in the holding circuit 81.

### <Specific Example of the MBE Operation>

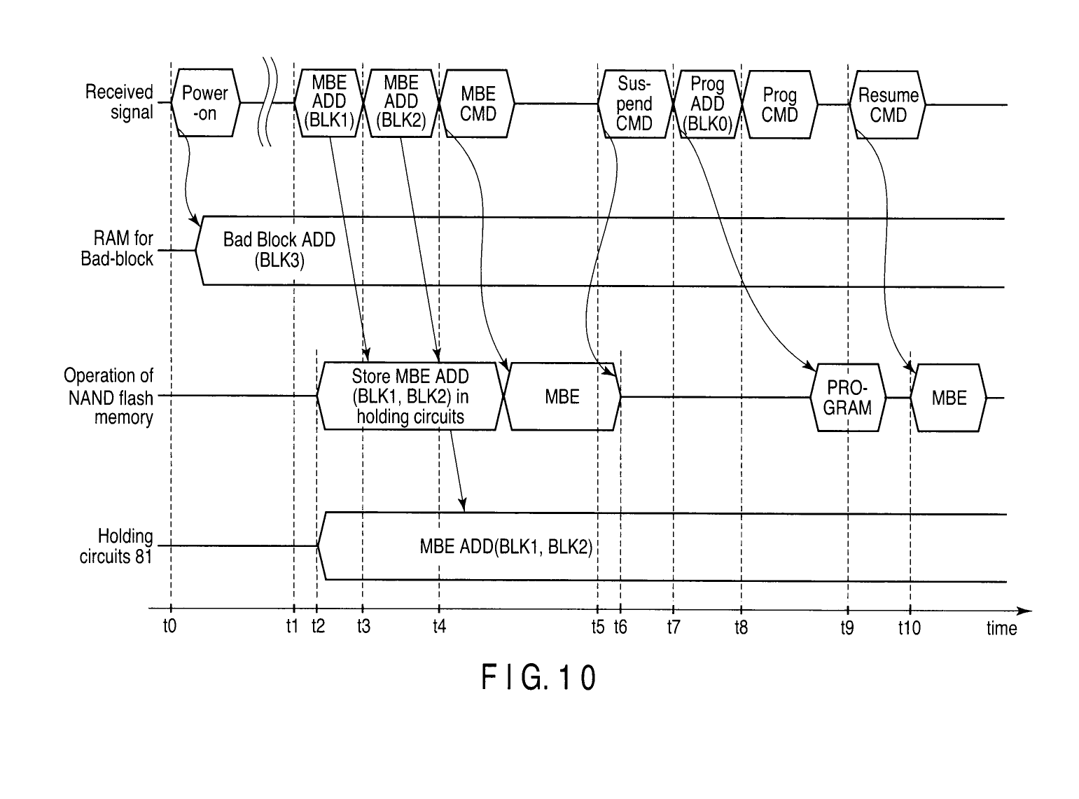

Now, a specific example of the MBE operation according to the present embodiment will be described with reference to FIG. 10. FIG. 10 is a timing chart showing receive signals from the host apparatus, the contents stored in the bad-block RAM in SRAM 30, the contents of operations performed by the NAND flash memory 2, and the contents stored in the holding circuit 81 in the block decoder 71. It is assumed below that the block BLK3 is a bad block.

As shown in FIG. 10, when the memory system 1 is powered on at time t1, the controller unit 4 reads a bad-block address from the ROM fuse block in the NAND flash memory 2 and allows the bad-block RAM in SRAM 30 to hold the bad-block address. It is assumed that at time t1 (and t3), the memory system 1 receives the addresses of blocks BLK1 and BLK2 as MBE addresses. Then, the controller unit 4 allows the holding circuit in the block decoder 71 in the NAND flash memory 2 to hold the MBE addresses (time t2). That is, all the holding circuits 81 are reset, and the holding circuits 81 in the block decoders 71-1 and 71-2 are set. After the storage of the MBE addresses in the holding circuit 81 is completed, when the memory system 1 receives the MBE command at time t4, the NAND flash memory 2 carries out MBE.

It is assumed that subsequently, at time t5 during execution of the MBE, the memory system 1 receives the suspend command at time t5. Then, in response to this, the NAND flash memory 2 suspends the MBE. The NAND flash memory 2 then allows the holding circuit 81 to hold the bad-block address (time t6).

Thereafter, at time t7, the memory system 1 receives a program address. Here, it is assumed that the program address corresponds to the block BLK0. Then, the controller unit 4 references the information in the bad-block RAM in SRAM 30 to determine whether or not the block BLK0, which is an access target, is bad block. If the block BLK0 is bad block, the controller unit 4 returns a program error to the host apparatus. Otherwise the controller unit 4 instructs the NAND flash memory 2 to program the data in the block BLK0.

It is assumed that thereafter, at time t9, upon receiving the resume CMD, the memory system 1 resumes the MBE operation based on the MBE addresses stored in the holding circuit 81 in the block decoder 71.

### <Effects of the Embodiment>

As described above, the semiconductor device and the method for controlling the semiconductor device according to the second embodiment facilitates the suspension and resumption of the MBE operation as in the case of the first embodiment.

In the configuration according to the present embodiment, the holding circuit 81 in the block decoder 71 is dedicated to MBE information. The bad-block information is read from the ROM fuse block and stored in SRAM 30, for example, when the memory system is powered on. To access the NAND flash memory 2, the controller unit 4 references the bad-block information in SRAM 30. This eliminates the need to store the bad-block information in the holding circuit 81 when the MBE operation is suspended, thus preventing the MBE information from being lost. The present embodiment thus facilitates the suspension and resumption of the MBE operation.

Of course, each block decoder 71 may have at least one holding circuit 81, allowing an increase in circuit area to be suppressed. Furthermore, compared to the first embodiment, the second embodiment enables a reduction in the size of the block decoder 71. The configuration according to the present embodiment eliminates the need for the read circuit 84 described in the first embodiment. The read circuit 84 is configured to output information indicating that any of the blocks BLK is bad, to a node PBUSBS when the holding circuit 81 holds the bad-block information. However, in the configuration according to the present embodiment, the holding circuit 81 avoids holding the bad-block information. This eliminates the need for the read circuit 84. In spite of the lack of the read circuit 84, the controller unit 4 can determines which of the blocks BLK is bad based on the information in SRAM 30.

Furthermore, the controller unit 4 reads the bad-block information from SRAM 30. This read operation can be performed in, for example, 1 clock (for example, 80 ns). Thus, compared to the case where the controller in the NAND flash memory 2 reads the bad-block information from the row decoder, the present embodiment enables read time to be substantially reduced.

In the present embodiment, the switch elements 100 and 101 are provided in association with the holding of the MBE information in the holding circuit 81. Turning on the switch element 101 during the MBE operation validates the information in the holding circuit 81, which determines the “H”/“L” level of the signal RDECADn. During this period, the signal FSEL=“L”. When the MBE operation is suspended, the switch element 101 is turned off to invalidate the information in the holding circuit 81. Also while the MBE operation is suspended, the signal FSEL=“L”, but the signal ROMBAEN is set to the “H” level to enable the paths in the MOS transistors 86 to 88.

During the normal loading, programming, and erase, the signal MSEL=“L”. The signal FSEL is at the “H” level, and the signal ROMBAEN=“H”.

Furthermore, the switch elements 100 and 101 can be effectively used for a test operation. In a die sort step during the test operation, data write is executed on all the blocks BLK (flash write). Data erase is also executed on all the blocks BLK (flash erase). However, it is important that even during flash write and flash erase, no voltage stress be applied to bad blocks.

For the flash write and the flash erase, the holding circuits 81 in all the block decoders 71 are preset (node L1=“H”). Then, in order to allow the bad block to be set, the signals ARROWA to ARROWE and ROMBAEN=“H” is set, and then the signal FRST=“H” is set. Then, the node L1=“L” is set. When the flash write and the flash erase are actually executed, the signal MSEL=“L”, the signal FSEL=“H”, and the signal ROMBAEN=“L” are set. Thus, the node L1 of the bad block can be set to the “L” level, with the nodes L1 of the other blocks set to the “H” level. As a result, data write or data erase can be executed on all the blocks other than the bad one. In this manner, the information held in the holding circuit 81 can be switched depending on an operation mode (normal mode/test mode). That is, the switch elements 100 and 101 enable or disable the selection of the block BLK executed by the holding circuit 81. For the test, the switch elements 100 and 101 enable or disable the selection of the block BLK executed by the holding circuit 81. If any block is bad, the switch elements 100 and 101 disable the selection of the block BLK executed by the holding circuit 81 corresponding to the bad block. The above-described control is performed by, for example, the controller unit 4.

As described above, according to the memory system according to the first and second embodiments, in the semiconductor device 1 in which the NAND flash memory 2 serving as a main storage, SRAM 30 serving as a buffer, and the controller 4 are formed on the same semiconductor substrate, SRAM 30 holds information on the block to be erased. When a plurality of blocks are erased in a batch, target block information is read from SRAM 30.

Alternatively, SRAM 30 holds the bad-block information. To execute data write and data read, the controller 4 references the bad-block information in SRAM 30 to determine whether or not the block to be accessed is bad.

In the above-described configuration, even if the erase operation being performed on a plurality of blocks is suspended, the erase operation can be resumed after the subsequent commands have been executed. This allows the usability of the memory system 1 to be improved.

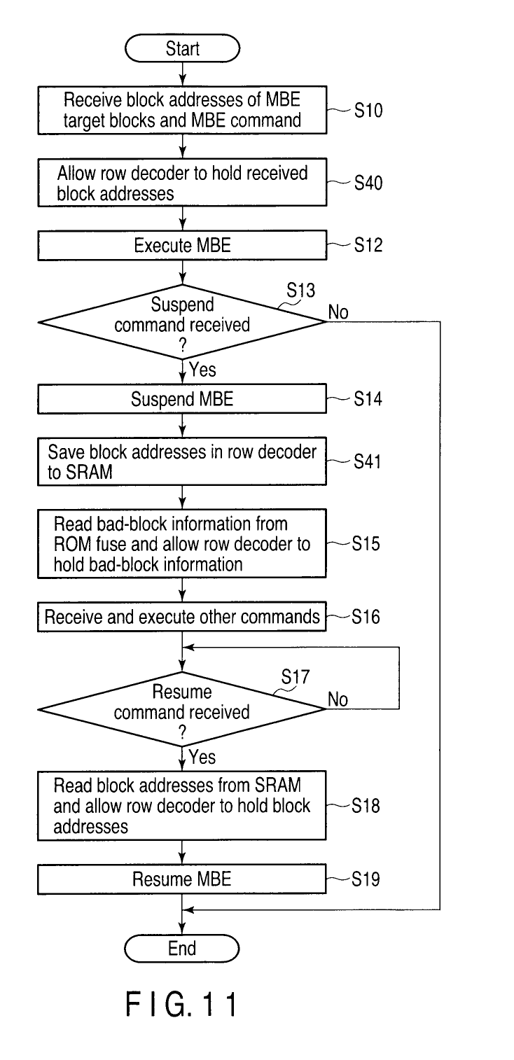

The above-described embodiments can be variously modified. The order of processing in each of the flowcharts can be changed to a maximum extent. For example, in the first embodiment, the timing when the MBE information is stored in SRAM 30 is not limited to the one when the MBE command is received. Such an example will be described with reference to FIG. 11. FIG. 11 is a flowchart showing the operation of the memory system 1. As shown in FIG. 11, after step S10, the controller unit 4 allows the row decoder 11 to hold the MBE addresses. Then, the controller unit 4 suspends MBE in step S14, and then retracts the MBE addresses in the row decoder 11 to SRAM 30 (step S41). After step S41, the controller unit 4 allows the row decoder 11 to hold the bad-block information. The processing may be executed, for example, in the above-described order.

Furthermore, in the second embodiment, the bad-block information need not necessarily be stored in SRAM 30. That is, the bad-block information may be read from the ROM fuse block as required. The present method eliminates the need for SRAM 30. However, in terms of operating speed, the bad-block information is desirably stored in SRAM 30.

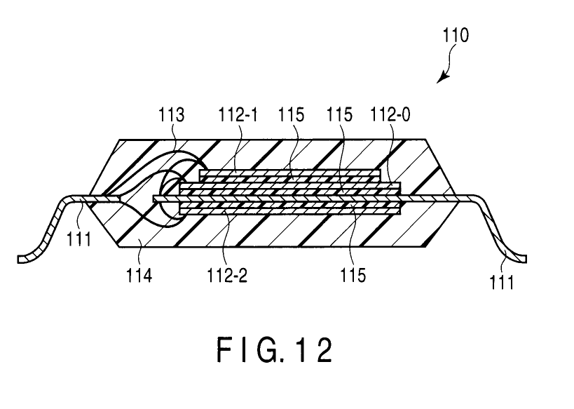

Moreover, in the description of the first and second embodiments, the NAND flash memory 2, the RAM unit 3, and the controller unit 4 are integrated on one chip. A specific example of such a memory system 2 is a flash memory of the “OneNAND (registered trade mark)” type. However, the embodiments are not limited to the one-chip structure. The NAND flash memory 2, the RAM unit 3, and the controller unit 4 may be implemented on the respective separate semiconductor chips. These semiconductor chips may be packaged together. An example is shown in FIG. 12. FIG. 12 is a sectional view of a semiconductor device (semiconductor package device) in which a plurality of semiconductor chips are packaged together.

As shown in FIG. 12, a semiconductor device 110 includes a lead frame 111, semiconductor chips 112-0 to 112-2, a bonding wire 113, and a sealing resin 114. The semiconductor chip 112-0 is bonded onto one surface of the lead frame 111 by a spacer 115 with a semiconductor element formation surface of the semiconductor chip 112-0 facing upward. Furthermore, the semiconductor chip 112-1 is further bonded onto the semiconductor chip 112-0 with a semiconductor element formation surface of the semiconductor chip 112-1 facing upward. Additionally, the semiconductor chip 112-2 is bonded onto the other surface of the lead frame 111 by the spacer 115 with a semiconductor element formation surface (bonding pad formation surface) of the semiconductor chip 112-2 facing upward. The bonding wire 113 connects the semiconductor chips 112-0 to 112-2 to the lead frame 111. The semiconductor chips 112-0 to 112-2, a part of the lead frame 111, and the bonding wire 113 are sealed with the resin 114 so as to form the semiconductor device 110. In the above-described configuration, for example, each of the semiconductor chips 112-0 to 112-2 is a semiconductor chip on which the RAM unit 3, the controller unit 4, and the NAND flash memory 2 are formed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor device comprising:
a NAND flash memory including a plurality of blocks with a plurality of memory cells and a decoder which selects the blocks, the NAND flash memory being capable of erasing data in a plurality of the blocks simultaneously during a multi-block erase operation, the decoder storing bad-block information at least during a read operation and a write operation and storing information on a plurality of erase target blocks during the multi-block erase operation;
an SRAM which stores the information on the erase target blocks; and
a controller which reads information on the erase target blocks from the SRAM to set the information into the decoder in a multi-block erase operation.

2. The device according to claim 1, wherein when the device receives an execution command for the multi-block erase operation, the information on the erase target blocks is set in the SRAM and the decoder, and
after the multi-block erase operation is suspended, when the device receives a resume command for the multi-block erase operation, the controller sets the information on the erase target blocks in the SRAM, in the decoder.

3. The device according to claim 1, wherein when the device receives an execution command for the multi-block erase operation, the information on the erase target blocks is set in the decoder,
when the device receives a suspend command for the multi-block erase operation, the controller sets the information in the decoder, in the SRAM, and
when the device receives a resume command for the multi-block erase operation, the controller sets the information in the SRAM, in the decoder.

4. The device according to claim 2, wherein during a suspension of the multi-blocks erase operation, the decoder resets the information on the erase target blocks and stores the bad-block information.

5. The device according to claim 3, wherein during a suspension of the multi-blocks erase operation, the decoder resets the information on the erase target blocks and stores the bad-block information.

6. The device according to claim 1, wherein the decoder includes a plurality of latch circuits associated with the respective blocks and storing the bad-block information and the information on the erase target blocks, and
depending on the information stored in each of the latch circuits, the associated blocks are inhibited from being accessed or permitted to be accessed.

7. The device according to claim 1, wherein the NAND flash memory, the SRAM, and the controller are formed on the same semiconductor substrate.

8. A semiconductor device comprising:
a NAND flash memory including a plurality of blocks with a plurality of memory cells and a decoder which selects the blocks, the NAND flash memory being capable of erasing data in a plurality of the blocks simultaneously during a multi-block erase operation, the decoder storing information on erase target blocks during the multi-block erase operation;
an SRAM which stores bad-block information; and
a controller which references the bad-block information in the SRAM during a write operation and a read operation to determine whether or not one of the blocks to be accessed is a bad block.

9. The device according to claim 8, wherein when the device receives an execution command for the multi-block erase operation, the information on the erase target blocks is set in the decoder, and
even while the multi-block erase operation is suspended, the decoder maintains the information on the blocks to be erased.

10. The device according to claim 9, wherein after a suspension of the multi-blocks erase operation, the NAND flash memory resumes the multi-block erase operation based on the information on the erase target blocks stored in the decoder.

11. The device according to claim 8, wherein the decoder includes:
a latch circuit provided for each of the blocks and storing the information on the erase target blocks; and
a switch which enables or disables a selection of any of the blocks by the latch circuit.

12. The device according to claim 11, wherein in a test operation of the NAND flash memory,
the controller allows the switch to enable the selection of the block by all the latch circuits, and
when a bad block is detected, the controller allows the switch to disable the selection of the block by the latch circuit corresponding to the bad block.

13. The device according to claim 11, wherein during the multi-block erase operation, the blocks are selected based on the information stored in the latch circuit, regardless of a block address.

14. The device according to claim 13, wherein during the write operation and the read operation, one of the blocks is selected based on the information stored in the latch circuit and the block address.

15. The device according to claim 8, wherein the NAND flash memory, the SRAM, and the controller are formed on a same semiconductor substrate.

16. A method for controlling a semiconductor device including a NAND flash memory including a plurality of blocks with a plurality of memory cells and a decoder which selects the blocks, the method comprising:
suspending a multi-block erase operation in response to a suspend command, data in a plurality of the blocks being erased simultaneously during the multi-block erase operation;
setting bad-block information in the decoder after the suspension;
reading or writing data from/to one of the blocks after the setting bad-block information;
reading the information on the blocks to be erased simultaneously, from SRAM and setting the information in the decoder, in response to a resume command after the reading or writing the data; and
resuming the multi-block erase operation after the setting the information on the blocks to be erased simultaneously.

17. The method according to claim 16, further comprising:
receiving the information on the blocks to be erased simultaneously and setting the information in the decoder and the SRAM, before the suspending the multi-block erase operation; and
starting the multi-block erase operation after the setting the information in the decoder and the SRAM.

18. The method according to claim 16, further comprising:
receiving the information on the blocks to be erased simultaneously and setting the information in the decoder and the SRAM, before the suspending the multi-block erase operation;
starting the multi-block erase operation, after the setting the information in the decoder and the SRAM; and
saving the information set in the decoder, to the SRAM, when suspending the multi-block erase operation.
